(19) United States
(12) Patent Application Publication
(10) Pub. No.: US 2023/0062663 A1
(43) Pub. Date: Mar. 2, 2023

(54) ELECTRONIC INTERFACE UNIT FOR AN ELECTRICAL HEATING DEVICE OF A HEATING, VENTILATION AND/OR AIR-CONDITIONING SYSTEM OF A MOTOR VEHICLE

(71) Applicant: VALEO SYSTEMES THERMIQUES, La Verriere (FR)

(72) Inventors: Erwan GOGMOS, La Verriere (FR); Yann COUAPEL, La Verriere (FR); Jonathan LEFLOCH, La Verriere (FR)

(73) Assignee: VALEO SYSTEMES THERMIQUES, La Verriere (FR)

(21) Appl. No.: 17/764,063

(22) PCT Filed: Sep. 22, 2020
(86) PCT No.: PCT/FR2020/051644

§ 371 Date: Oct. 18, 2022

(30) Foreign Application Priority Data
Sep. 27, 2019 (FR) FR1910716

(51) Int. Cl. B60H 1/22; F24H 3/04; F24H 9/1863

(52) U.S. Cl. CPC B60H 1/2225; F24H 3/0476; F24H 3/0441; F24H 9/1872; B60H 2001/2278; F24H 2250/04

(57) ABSTRACT

The invention, according to a first aspect, relates to a cover (4) of an electronic interface housing (300) of an electrical heating device for a motor vehicle, the cover (4) comprising at least one pressing member (44a, 44b) and at least one pressing element (45) which are configured to be in contact with a printed circuit board (5) when the cover (4) is fixed on the electronic interface housing (300), a free end of the at least one pressing member (44a, 44b) extending in a first transverse plane (451) and a free end (4501) of the at least one pressing element (45) extending in a second transverse plane (452), the at least one pressing member (44a, 44b) and the at least one pressing element (45) being arranged so that they project, in a direction perpendicular to a reference plane (400) of the cover (4), from an inner face of the cover (4) intended to face toward the inside of the electronic interface housing (300), characterized in that the first transverse plane (451) and the second transverse plane (452) are substantially parallel to one another and to the reference plane of the cover, strictly not coincident with one another or with the reference plane (400) of the cover (4), the second transverse plane (452) being, in a direction perpendicular thereto, closer to the reference plane (400) of the cover (4) than the first transverse plane (451).

The technical field of the present invention is that of ventilation, heating and/or air conditioning of motor vehicles. The present invention relates more particularly to electrical heating devices intended to form part of a ventilation, heating and/or air conditioning system of a motor vehicle.

The invention has a preferred application in an electrical heating device, or electrical heating device comprising heating modules which heat by the diffusion of heat under the effect of an electrical potential, that is to say resistive heating elements. Examples may include positive temperature coefficient resistors (also known as PTC resistors), which provide rapid heat generation in vehicles when these are electrically powered.

Such electric heaters comprise, for example, an open-worked frame configured to house heating modules as described above, such that these heating modules are in contact with an airflow passing through the frame. Such a frame comprises, for example, compartments receiving at least one heating module which can be formed of a tube inside which there are housed electrodes which surround the resistive heating elements. On the outside of the tube, the electrodes are continued by connecting terminals that extend by connecting terminals, which in turn extend to connection terminals, which are themselves connected to a printed circuit board. The connection terminals, the printed circuit board and the other electronic components necessary for the operation of the electrical heating device are integrated in an electronic interface housing which comprises a base receiving these components and a cover which covers the base to protect them.

The development of the technologies and thermal needs of vehicles leads to the implementation of electrical heating devices supplied with high voltage, so as to deliver, by the resistive elements, a thermal power able to heat the air passing through the ventilation, heating and/or air conditioning system without the need to add an additional heat exchanger. These high-voltage devices require more and larger electronic components, which leads to an increase in the size and volume of the electronic interface housings in which these electronic components are housed. The increase in size and volume of such electronic housings leads, in turn, to an increase in the size and, in particular, the surface area of the covers of these housings, making these covers more prone to deformation.

One problem with such devices is therefore the rigidity of the cover of the electronic interface housing, which, due to its large surface area, is easily subject to deformation under the effect of external mechanical stresses such as, for example, those resulting from vibrations induced by the motion of the vehicle, or those occurring during the assembly of the electrical heating device with the connecting terminals and the connection terminals fitted into each other. The present invention is part of this search for a simple solution, allowing the realization of a cover for an electronic interface housing that is easy to assemble with a base of such a housing, sufficiently rigid to resist the aforementioned stresses, and sufficiently flexible to allow easy assembly with the previously mentioned base, without risk of damage to the electronic components housed in the housing.

To this end, the invention, according to a first aspect, relates to a cover of an electronic interface housing of an electrical heating device for a motor vehicle, the cover comprising at least one pressing member and at least one pressing element which are configured to be in contact with a printed circuit board when the cover is fixed on the electronic interface housing, a free end of the at least one pressing member extending in a first transverse plane and a free end of the at least one pressing element extending in a second transverse plane, the at least one pressing member and the at least one pressing element being arranged so that they project, in a direction perpendicular to a reference plane of the cover, from an inner face of the cover intended to face toward the inside of the electronic interface housing characterized in that the first transverse plane and the second transverse plane are substantially parallel to one another and to the reference plane of the cover, strictly not coincident with one another or with the reference plane of the cover, the second transverse plane being, in a direction perpendicular thereto, closer to the reference plane of the cover than the first transverse plane.

According to one example, the cover according to the invention is made by injection, into a mold, of a plastics material chosen for its thermal properties and for its mechanical properties of both flexibility and rigidity. Advantageously, the electronic interface housing on which the cover according to the invention is intended to be fixed is also made by injection, into a mold, of a plastics material. According to different examples, the materials chosen to produce the cover and the electronic interface housing are identical or different. The invention is also applicable without restriction in the case where all or part of the electronic interface housing is produced from a metal material formed from thin sheet metal, the mechanical properties of which, due to the thinness of the sheet metal used, are comparable to those of a plastics material.

According to an optional feature of the invention, the cover has a perimeter and a main wall that has a generally substantially flat form. In particular, the plane in which the main wall of the cover extends primarily can be referred to as the reference plane of the cover. The at least one pressing member and the at least one pressing element extend so that they project from an inner face of the cover in a direction perpendicular to the aforementioned reference plane and are oriented such that, when the cover according to the invention is arranged in place and fixed on the previously mentioned electronic interface housing, they are directed toward the electronic components housed in the housing.

As mentioned, according to the invention, the first transverse plane and the second transverse plane, defined by the free ends of the pressing members or elements, are substantially parallel to one another and to the reference plane of the cover, strictly not coincident with one another or with the reference plane of the cover. In other words, one of the previously defined transverse planes is, in a direction perpendicular to the reference plane of the cover, closer to the aforementioned reference plane than the other. That is to say, the free ends of the at least one pressing member and the at least one pressing element are offset from one another in a direction, also referred to as the axial direction, perpendicular to the reference plane of the cover.

In other words, a dimension, measured in the aforementioned axial direction, that is to say perpendicularly to the reference plane of the cover, of one of the pressing means, namely the at least one pressing member or the at least one pressing element, is smaller than the dimension, measured in the same axial direction, of the other pressing means.

As a result of the foregoing, there is a slight clearance, when the cover according to the invention is placed on the electronic interface housing, between the at least one pressing element and the printed circuit board with which this pressing element is intended to be in contact once the cover is fixed on the electronic interface housing. It is to be understood here that this clearance is dimensioned so that, when the cover is fixed on the housing, the at least one pressing element is effectively in contact with the previously mentioned printed circuit board. According to one example, this clearance, or offset, measured in the aforementioned axial direction, that is to say perpendicularly to the reference plane, between the first transverse plane and the second transverse plane, is of the order of 1 to a few tenths of a millimeter. Preferably, but not exclusively, this offset is less than 5 tenths of a millimeter. It should be noted that the direction perpendicular to the reference plane of the cover, or axial direction, is also the direction of placement of the cover on the electronic interface housing.

According to various features, taken individually or in combination:
the cover comprises means for elastic fixing by click and ratchet onto a base of the electronic interface housing, and the at least one pressing element is located between a pressing member and an edge of the cover on which the means for elastic fixing are arranged.
the at least one pressing element comprises a plurality of pins arranged so that they project from the inner face of the cover, perpendicularly to the reference plane thereof. Advantageously, the pins are all identical, for example cylindrical. The previously mentioned second transverse plane is therefore defined by the free ends of all these pins.
the pins of the at least one pressing element are arranged in a staggered pattern along at least two transverse lines. More precisely, according to this feature, the bases of the pins of the pressing element, by which said pins are connected to the inner face of the cover according to the invention, are organized, on this inner face, in at least two lines substantially parallel to one another. Furthermore, according to this feature, the aforementioned pins are arranged in a staggered fashion along the two aforementioned transverse lines. Such a surface arrangement of the pins constituting the at least one pressing element allows a precise definition of the second transverse plane previously described. Furthermore, in an electronic interface housing equipped with a cover according to the invention, such an arrangement of the pins localizes the previously mentioned clearance, or offset, over the entire surface of the region of the cover in which the pins are arranged. The above-mentioned clearance thus becomes a surface clearance, allowing the click and ratchet force to be distributed over the entire surface of the cover region in which the pins extend. In a case in which the pins of the pressing element are arranged in a region of the cover intended to overlap a printed circuit board housed in the electronic interface housing, this helps to protect the electronic components from undue stress and damage when assembling the cover with the electronic interface housing.
the pins constituting the at least one pressing element are arranged so that they project from a deformed zone of the inner face of the cover. Advantageously, the deformation of this zone is directed, when the cover is fixed on the electronic interface housing, toward the inside of said housing, that is to say toward the electronic components housed therein and, in particular, toward the previously mentioned printed circuit board. According to an example, this deformed zone constitutes, seen from the outer face of the cover, opposite the inner face of the latter in a direction perpendicular to the reference plane thereof, the form of a trough that sits within the electronic interface housing when the cover is fixed to the latter. The shape of the deformed zone means that it constitutes a pressing means for the cover complementary to the at least one pressing member and the at least one previously mentioned pressing element. More particularly, the presence of such a deformed zone makes it possible, in particular, to reduce, or even eliminate, any risk of deformation of the cover under the effect of vibrations and/or stresses resulting from the motion of the vehicle or induced by the assembly operation of the electrical heating device.
the at least one pressing member comprises at least one rib substantially perpendicular to the first transverse plane. According to one example, the at least one pressing member comprises a first portion, for example substantially cylindrical, and a second portion that extends from the first portion so as to form a substantially planar rib of which the plane contains the axis of the first substantially cylindrical portion. According to one example, the aforementioned rib extends from the inner face of the cover, and a dimension thereof, measured perpendicularly to the reference plane of the cover, is substantially equal to the dimension, measured along the same direction, of the first portion of the at least one pressing member. As a result, the first transverse plane is defined both by the free end of the first portion of the at least one pressing member and by the axial dimension of the aforementioned rib. It is therefore to be noted that, according to such a configuration, the first transverse plane is defined by the free end of a single pressing member, whereas the second transverse plane is defined by the free ends of a plurality of pins. Alternatively, the at least one pressing member may comprise a first rib and a second rib that extend symmetrically on either side of the first portion of the pressing member. According to one example, the cover comprises a plurality of pressing members of either or both of the aforementioned types.

The invention thus achieves its set objective by proposing, thanks to simple solutions, a cover for an electronic interface housing of an electrical heating device of a ventilation, heating and/or air conditioning system for a motor vehicle, which cover has, on the one hand, sufficient rigidity to withstand, in particular, the vibrations and stresses induced by the motion of the vehicle, and, on the other hand, sufficient flexibility to allow it to be fixed to the electronic interface housing without risk of damage to the electronic components housed in this housing under the effect of the stresses exerted when the cover is arranged in place.

According to a second aspect, the invention extends to an electronic interface housing of an electrical heating device of a motor vehicle, comprising a cover as previously described, as well as a base configured to house a printed circuit board, the base comprising click and ratchet means configured to cooperate with means for elastic fixing carried by the cover in order to close a cavity for receiving the printed circuit board.

Advantageously, the click and ratchet means carried by the base are configured to cooperate with means for elastic fixing, carried by the cover, located in the vicinity of the at least one previously mentioned pressing element.

According to an advantageous feature of the invention, such an electronic interface housing comprises an electrical connection zone and a connection zone to heating elements of an electrical heating device of the motor vehicle, and the at least one pressing element of the cover is located in the vicinity of the connection zone to the heating elements of the electrical heating device.

As previously mentioned, the invention finds a preferred application in an electrical heating device comprising at least one heating module formed by a tube inside which there are housed electrodes which surround resistive heating elements, and in which the electrodes are extended, outside the tube, by connecting terminals which extend to connection terminals which are themselves connected to the previously mentioned printed circuit board placed in the electronic interface housing. In addition to the connection zone of the printed circuit board to the electrodes of the heating elements, such a housing also comprises an electrical connection zone by which the printed circuit board is connected to an electrical power supply device, for example an electrical power supply device specific to the ventilation, heating and/or air conditioning system, or an electrical power supply device of the vehicle.

As a result of the above, the connection zone to the electrodes of the heating elements is, mechanically, the most fragile. The arrangement of the at least one pressing element of the cover in the vicinity of this zone therefore allows this zone of the electronic interface housing to be protected, by means of the previously defined and described clearance. The force exerted on the connection zone to the heating elements when the cover is arranged in place and fixed on the base of the housing according to the invention is therefore reduced, thus avoiding stress and damage to the connection elements present in this region.

Advantageously, in the electronic interface housing according to the invention, the printed circuit board is sandwiched between the at least one pressing member of the cover and a reinforcing element arranged in the base. It is to be understood here that the reinforcing element is arranged in a direction perpendicular to the reference plane of the cover, and that the sandwiching occurs once the cover is arranged in place and fixed on the base of the housing by the previously mentioned means for elastic fixing by click and ratchet. This makes it possible to ensure in particular that the printed circuit board is held in place and minimizes the vibrations that it may experience while the vehicle is in motion.

The invention lastly extends to an electrical heating device for heating an airflow in a motor vehicle, comprising at least one heating element and an electronic interface housing as previously described.

Other features and advantages of the present invention will become more clearly apparent from the description and the drawings, in which:

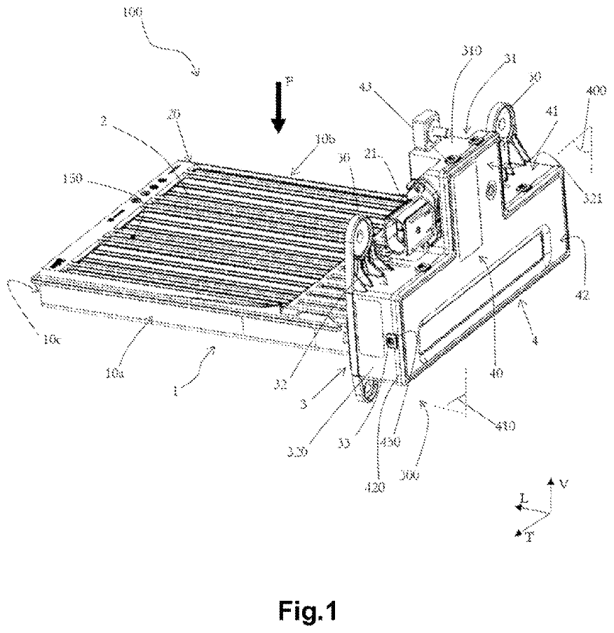

FIG. 1 illustrates schematically in perspective an electrical heating device intended for ventilation, heating and/or air conditioning system of a motor vehicle,

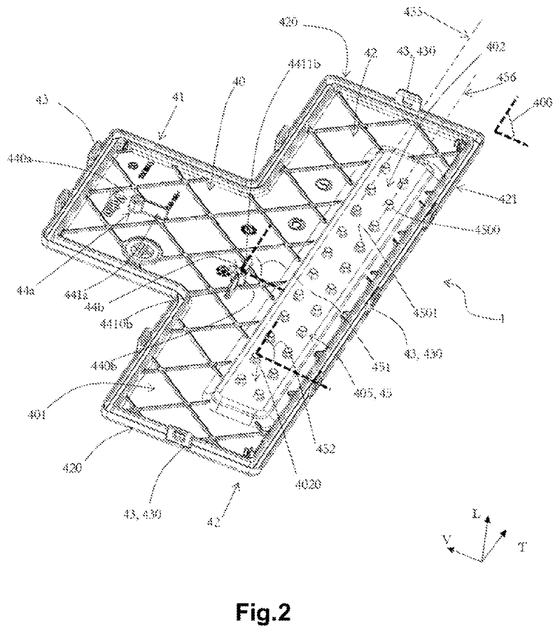

FIG. 2 is a schematic perspective view of a cover of an electronic interface housing according to a first aspect of the invention, as viewed from the side of the inner face thereof, intended to face toward the inside of the electronic interface housing of an electrical heating device such as that illustrated in FIG. 1,

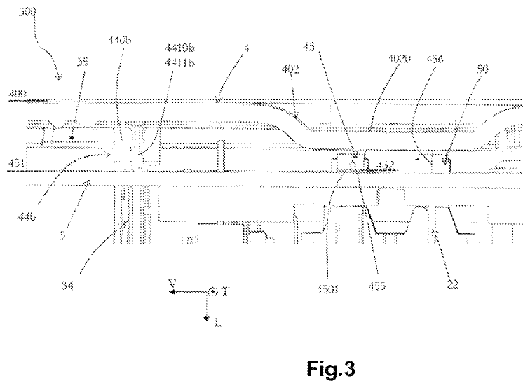

FIG. 3 is a partial cross-sectional view, in a plane perpendicular to its reference plane, of a cover and a housing such as those illustrated in FIG. 2,

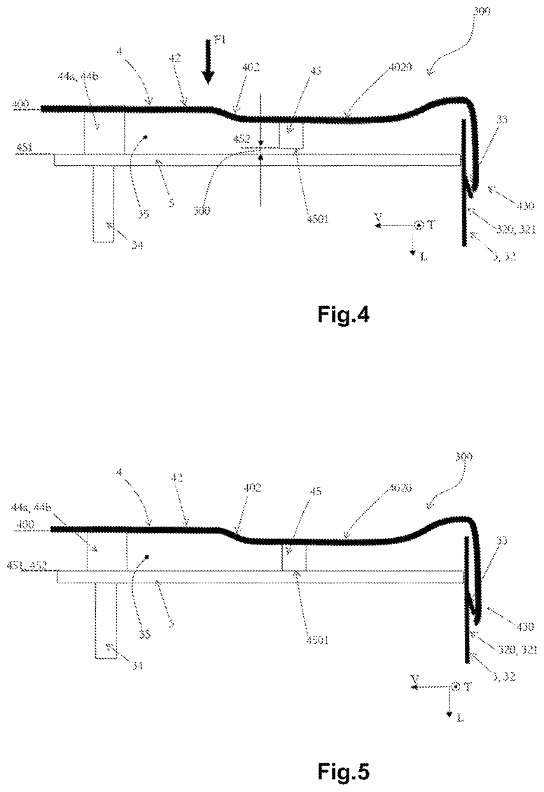

FIG. 4 illustrates schematically, in cross-section in a plane perpendicular to the reference plane of the cover, the placement and fixing of a cover on an electronic interface housing such as those illustrated in FIG. 3, with FIG. 4 illustrating more particularly the electronic interface housing and the cover before the latter is elastically fixed by click and ratchet,

FIG. 5 is a view similar to that of FIG. 4, specifically illustrating the electronic interface housing and the cover once the cover is fixed by click and ratchet on a base of the housing.

It should first of all be noted that although the figures set out the invention in detail for implementing the invention, these figures may of course be used in order to better define the invention if necessary. It should also be noted that these figures set out only some of the possible exemplary embodiments according to the invention.

With reference to FIG. 1, an electrical heating device 100 suitable for equipping a ventilation, heating and/or air conditioning system of a motor vehicle comprises, in particular, a frame 1 in which there are arranged a plurality of heating elements 2, the role of which is to heat an airflow passing through the frame 1. The direction of such an airflow is represented by the arrow F in FIG. 1. The electrical heating device 100 also comprises an electronic interface housing 300 configured to house the set of electronic components that make it possible to both electrically power the electrical heating device 100 and control its operation.

According to the example more particularly illustrated in FIG. 1, the frame 1 has substantially the form of a rectangular parallelepiped, the largest dimension of which extends in a longitudinal direction L of the electrical heating device 100. More precisely, the frame 1 is formed of two substantially flat side walls 10a, 10b, which are substantially parallel to one another, except for manufacturing tolerances, and of a substantially flat bottom wall 10c perpendicular to the side walls 10a, 10b. The side walls 10a, 10b and the bottom wall 10c together form a U, with the bottom wall 10c forming the base, and together they delimit a space 150 for receiving the heating elements 2. As shown in FIG. 1, the side walls 10a, 10b of the frame 1, extend mainly in the previously mentioned longitudinal direction L, and the bottom wall 10c, which is substantially perpendicular to the side walls 10a, 10b, extends mainly in a transverse direction T of the electrical heating device 100, the transverse direction T being perpendicular to the previously defined longitudinal direction L. The walls 10a, 10b, 10c also extend, perpendicularly to the longitudinal direction L and to the transverse direction T, in a vertical direction V of the electrical heating device 100, such that the directions L, T, V, together form a direct trihedron. It should be noted that the vertical direction V is also, as shown in FIG. 1, the direction of passage of an airflow to be heated in the electrical heating device 100. It should also be noted that the above-mentioned longitudinal, transverse, and vertical directions may, in a motor vehicle equipped with an electrical heating device 100, have any orientation with respect to the longitudinal, transverse, and vertical directions of the vehicle in question.

With reference to the directions and orientations defined above, the electronic interface housing 300 is placed at the longitudinal end of the frame 1 opposite the bottom wall 10c thereof, so as to close the opening of the U formed by the walls 10a, 10b, 10c, of the frame 1 upon assembly of the electrical heating device 100.

In the receiving space 150, in particular delimited by the walls 10a, 10b, 10c of the frame 1, each heating element 2 extends substantially parallel to the side walls 10a, 10b, of the frame 1, that is to say substantially parallel to the longitudinal direction L of the electrical heating device 100. Each heating element 2 thus comprises, in the longitudinal direction L of the electrical heating device 100, a first end 20 arranged in the vicinity of the bottom wall 10c of the frame 1 and a second end 21 arranged in the vicinity of the electronic interface housing 300.

It should be noted that the electrical heating device according to the invention could be realized without a frame, which has been described here as a structural element making it possible in particular to protect the heating elements and to facilitate the insertion of the electrical heating device in the ventilation, heating and air conditioning system, moreover in particular to lighten the device. In this context, the heating elements remain integral with the electronic interface housing and are traversed by an airflow, and the structure of the electronic interface housing is unchanged from what will follow.

The electronic interface housing 300 comprises a base 3 and a cover 4. The base 3 is configured to house electronic components for powering and controlling the operation of the heating elements, and the cover 4 is configured to overlap an opening in the base 3 to protect the aforementioned electronic components. These electronic components comprise, in particular, a printed circuit board 5, not visible in FIG. 1, configured to control and monitor the operation of the heating elements 2. The base 3 thus forms a cavity 35, not denoted in FIG. 1, for receiving the aforementioned electronic components and, in particular, the printed circuit board 5.

As shown in FIG. 1, the base 3 comprises fixing members 30 making it possible to fix the heating device 100 in a casing of a ventilation, heating and/or air conditioning system of a motor vehicle.

Here, the base 3 has the general shape of a T comprising a first portion 31 and a second portion 32, one dimension of which, in the transverse direction T of the electrical heating device 100, is greater than a transverse dimension of the first portion 31. The second portion 32 of the base 3 is located, in the longitudinal direction L of the electrical heating device 100, in the extension of the heating elements, and the first portion 31 of the base 3 is located, in the vertical direction V of the electrical heating device 100, in the extension of the second portion 32. In the aforementioned transverse direction T, the first portion 31 and the second portion 32 of the base 3 are substantially centered with respect to one another. The previously mentioned receiving cavity 35 advantageously extends into the first portion 31 and into the second portion 32 of the base 3.

The cover 4 is located opposite, in the longitudinal direction L of the electrical heating device 100, the portion by which the electronic interface housing 300 and, more specifically, the base 3 thereof, is connected to the heating elements. The cover 4 comprises a substantially planar main wall 40, which extends primarily along a plane 400 defined by the transverse direction T and by the vertical direction V of the electrical heating device 100. The aforementioned plane 400 will be referred to in the following as the reference plane of the cover 4.

With reference to FIG. 1, the cover 4 has a T-shape complementary to that of the base 3, comprising a first portion 41, the shapes and dimensions of which are complementary to the shapes and dimensions, projected in the reference plane 400, of the first portion 31 of the base 3, and a second portion 42, the shapes and dimensions of which are complementary to the shapes and dimensions, projected in the reference plane 400, of the second portion 32 of the base 3. More specifically, the shapes and dimensions of the first portion 41 and the second portion 42 of the cover 4 are defined in such a way that the cover 4, when fixed to the base 3, completely covers and closes the opening of the previously defined receiving cavity 35. According to the example more particularly illustrated by FIG. 1, the receiving cavity 35 extends substantially over the whole of the base 3, the cover 4 overlapping the latter.

The base 3 and the cover 4 also comprise means allowing the cover 4 to be elastically fixed to the base 3 by click and ratchet. According to the example more particularly illustrated by FIG. 1, these means comprise in particular, on the one hand, at least one lug 33 arranged so that it projects from a wall of the base 3 and, on the other hand, complementary means 43 arranged so that they project from the periphery of the cover 4. According to the example more particularly illustrated by FIG. 1, a plurality of lugs 33 are distributed on the side walls of the base 3. In particular, a lug 33 is arranged on each side wall 320, substantially parallel to a vertical longitudinal plane 410, of the second portion 32 of the base 3. According to the example more particularly illustrated by FIG. 1, lugs 33 are also arranged on a longitudinal wall 321 of the second portion 32 of the base 3, perpendicular to the aforementioned side walls 320, as well as on a longitudinal wall 310 of the first portion 31 of the base 3. Advantageously, the cover 4 has as many means for elastic fixing by click and ratchet 43 as the base 3 has lugs 33.

FIG. 2 shows more specifically the cover 4 of an electrical heating device 100 such as the one illustrated in FIG. 1, seen from the inner side thereof, that is to say seen from the side thereof intended to be placed opposite the receiving cavity 35 when the cover 4 is fixed on the base 3. As a reminder, the receiving cavity 35 is configured to receive the electronic components for actuating and controlling the operation of the heating elements 20 of the electrical heating device 100.

FIG. 2 shows the reference plane 400 of the cover 4, previously defined, as well as the main wall 40, the first portion 41 and the second portion 42 of the cover 4. Also shown in FIG. 2 is the previously defined trihedron (L, V, T) of the electrical heating device 100 as illustrated in FIG. 1, the previously mentioned side walls 420 of the second portion 42 of the cover 4, and the means for elastic fixing by click and ratchet 43 complementary to the previously described lugs 33. These means 43 take the form here of eyelets with an opening configured to cooperate with the lugs. According to the example illustrated in FIG. 2, the cover 4 comprises in particular a plurality of means for elastic fixing by click and ratchet 430 located on the side walls 420 of the second portion 42 of the cover 4.

According to the example more particularly illustrated by FIG. 2, the cover 4 comprises, extending in a manner projecting from the inner face 401 of its main wall 40, a first pressing member 44a, arranged in the first portion 41 of the cover 4, and a second pressing member 44b, arranged in the second portion 42 of the cover 4.

The first pressing member 44a and the second pressing member 44b extend, from the inner face 401 of the main wall 40 of the cover 4, substantially perpendicularly to the reference plane 400 of the cover 4. More specifically, the first pressing member 44a and the second pressing member 44b are connected to the inner face 401 of the cover 4 by one of their ends in the longitudinal direction L, and their opposite end, in said longitudinal direction L, is free. The pressing members 44a, 44b, thus extend toward the inside of the electronic interface housing 300 when the cover is connected to the base of the electronic interface housing.

According to the invention, the free ends of the first pressing member 44a and of the second pressing member 44b together define a first transverse plane 451, which is substantially parallel to the vertical direction V and to the transverse direction T of the cover 4 and of the electrical heating device 100 and in particular is visible in FIG. 3. The first transverse plane 451 is therefore, except for manufacturing tolerances, substantially parallel to the reference plane 400 of the cover 4.

According to the example more particularly illustrated by FIG. 2, the first pressing member 44a comprises a first, substantially cylindrical portion 440a, the axis of which is, except for manufacturing tolerances, substantially perpendicular to the reference plane 400, and a second, substantially flat portion 441a, forming a rib which extends from the aforementioned first portion 440a. More specifically, the second portion 441a extends in a plane perpendicular to the reference plane 400 containing the axis of the first portion 440a. According to the example shown in FIG. 2, which is not exclusive, the second portion 441a of the first pressing member 44a extends in a 5 plane substantially parallel to a vertical longitudinal plane defined by the longitudinal direction L and vertical direction V of the electrical heating device 100.

According to the example more particularly illustrated by FIG. 2, the second pressing member 44b comprises, in the same way as the first pressing member, a first, substantially cylindrical portion 440b, the axis of which is, except for manufacturing tolerances, substantially perpendicular to the reference plane 400. Advantageously, a dimension, measured perpendicularly to the reference plane 400, of the first portion 440b of the second pressing member 44b, is identical to a dimension, measured in the same direction, of the first portion 440a, of the first pressing member 44a.

The second pressing member 44b also comprises a second substantially planar portion, which extends from the aforementioned first portion 440b. The second portion of the second pressing member 44b extends in a plane containing the longitudinal axis of the first portion 440b, and here is in the form of two ribs 4410b, 4411b diametrically opposed with respect to said first portion 440b and which extend in a transverse longitudinal plane defined by the longitudinal direction L and transverse direction T of the electrical heating device 100. It should be noted that these two ribs of the second pressing member 44b are arranged perpendicularly to the second portion 441a of the first pressing member 44a.

It was previously specified that the free ends of the first pressing member 44a and of the second pressing member 44b together define a first transverse plane 451, which is substantially parallel to the reference plane 400 of the cover 4. This first transverse plane 451 is defined by the free ends of the ribs 441a, 4410b, 4411b, that is to say by the longitudinal dimension thereof. According to the example illustrated in FIG. 2, the longitudinal dimensions, measured perpendicularly to the reference plane 400 of the cover 4, of the ribs of each pressing member are identical, and they are here slightly larger than the corresponding dimensions of the first portions of each pressing member.

The cover 4 also comprises a pressing member 405, which here takes the form of a plurality of pins 45 extending so that they project from the inner face 401 of the main wall 40 of said cover. As shown in FIG. 2, the pins 45 extend from the previously defined inner face 401 of the cover 4 in a direction substantially perpendicular to the reference plane 400 of the latter. In other words, similarly to the pressing members 44a, 44b, the pins 45 extend toward the inside of the electronic interface housing 300.

The pins 45 are here arranged in the second portion 42 of the cover 4. According to the example shown in FIG. 2, the pins 45 are substantially cylindrical, with an axis perpendicular to the reference plane 400. Each pin 45 thus comprises, in a longitudinal direction perpendicular to the reference plane 400, a first end 4500 by which it is connected to the inner face 401 of the cover 4, and a second, free end 4501.

According to the invention, the free ends 4501 of the pins 45 together define a second transverse plane 452, parallel to the reference plane 400, and not coincident with the latter. For this purpose, the longitudinal dimensions, measured perpendicularly to the reference plane 400, of the pins 45 are all identical. More particularly, and as will be particularly apparent in FIG. 3, the second transverse plane 452 is closer to the reference plane 400 than is the first transverse plane 451.

According to the example shown in FIG. 2, the pins 45 are arranged so that they project from a deformed zone 402 of the main wall 40 of the cover 4. More specifically, the deformed zone 402 constitutes a trough shape, of which the bottom 4020, substantially parallel to the reference plane 400 of the cover 4, extends offset, in the longitudinal direction L, from the inner face 401 of the cover 4, toward the inside of the electronic interface housing 300.

This deformed zone 402 extends, in the second portion 42 of the cover 4, in the vicinity of the means for elastic fixing by clock and ratchet 430 arranged on the side walls 420 of this second portion. As a result, the pins 45 are also located in the vicinity of these means for elastic fixing 430, and in particular between these means for elastic fixing 430 and the second pressing member 44b.

According to the example shown in FIG. 2, the pins 45 are distributed along two lines 455, 456 parallel to one another and staggered with respect to one another on these two lines. Furthermore, the pins 45 are here arranged substantially on the entire bottom 4020 of the deformed zone 402, parallel to the reference plane 400 of the cover 4.

FIG. 3 shows a detail of the electronic interface housing 300, in a position in which the cover 4 is placed, but not fixed, on the base 3. This detail makes it possible, in particular, to see, on the one hand, the deformed zone 402 and the studs 45 of the pressing element as previously described and, on the other hand, the second pressing member 44b, its first portion 440b and one of its ribs 4410b, 4411b.

More precisely, FIG. 3 shows a pin 45 of the previously described line 455 of pins, as well as, in line with the other line 456, the end of a connection terminal 50 of a heating element able to cooperate with an electrode 22 of this heating element, the pins 45 being arranged in a staggered manner from one line to the other.

According to the invention, it is provided that the pressing members 44a, 44b and the pins 45 are in contact with the printed circuit board 5 when the cover 4 is fixed on the base 3 of the electronic interface housing 300, by cooperation of the means for fixing by click and ratchet carried by the cover and the base.

FIG. 3 shows that, prior to this fixing of the cover on the base, when the cover is positioned opposite the base, the rib 4410b, 4411b, and more generally each of the ribs of the pressing members, is in contact with the printed circuit board 5, whereas the pin 45, and more generally each of the pins, is not in contact with the printed circuit board. More specifically, the invention provides that, in the position in which the cover 4 is placed on the base 3 of the electronic interface housing 300, but is not fixed thereto, the first transverse plane 451 and the second transverse plane 452, previously described, are, in a direction perpendicular to the reference plane 400, longitudinally offset from one another and from the reference plane 400. The longitudinal offset between the first transverse plane 451 and the second transverse plane 452 is in the order of 1 to a few tenths of a millimeter, and preferably less than 5 tenths of a millimeter. This offset results in a clearance for the fixing of the cover 4 and thus gives the cover a certain flexibility in the region in which the pins 45 are arranged.

It then follows from the arrangement of the pins 45 in the second portion 42 of the cover 4, that is to say in the portion of this cover intended to cover the region of the electronic interface housing 300 in which the connection zone to the heating elements of the electrical heating device 100 is located, that this prevents any excessive stress on the connecting terminals 50 and the corresponding electrodes 22 when the cover is fixed to the base.

The assembly clearance, permitted by the axial offset of the free ends of the ribs and studs as previously described, is achieved over the entire surface of the region in which the studs 45 are disposed, that is to say according to the example shown in the figures, over the entire surface of the bottom 4020 of the deformed zone 402. This allows for a better distribution of the force for fixing the cover in this region.

It can also be seen in FIG. 3 that the printed circuit board 5 is sandwiched between the rib 4410b, 4411b of the second pressing member 44b and a stud 34 of the base 3. In particular, this makes it possible to ensure that the printed circuit board 5 is held securely in the electronic interface housing 300, reducing the effect of vibrations that may result from the motion of the vehicle equipped with the electrical heating device 100, as well as when the cover 4 is placed and fixed on the base 3.

What has just been described with reference to FIG. 3 is illustrated schematically in FIG. 4, specifically a representation of the electronic interface housing 300 in a position in which the cover 4 placed on the base 3, but not fixed to the latter, and FIG. 5 illustrates the same electronic interface housing 300, this time in a position in which the cover 4 is fixed on the aforementioned base 3.

Thus, these FIGS. 4 and 5 show the cover 4, its reference plane 400, the deformed zone 402 and its bottom 4020, a pressing member 44a, 44b, as well as a pin 45 and the stud 34 previously described. These figures also show schematically a lug 33 arranged so that it projects from a side wall 320, 321 of the second portion 32 of the base 3, as well as an eyelet 430 forming a means for elastic fixing by click and ratchet in the second portion 42 of the cover 4. It should be noted here that, if the pressing member 44b schematically referenced here may be of the type of the second pressing member 44b previously described with two ribs 4410b, 4411b, it may also be of the type of the first pressing member 44a with a single rib 441a, the pressing member illustrated in FIGS. 4a and 4b being the one closest to the pins 45 arranged in the second portion 42 of the cover 4.

As shown in FIG. 4, in the position in which the cover 4 is placed on the base 3 but not fixed thereto, the first transverse plane 451 and the second transverse plane 452 are offset from one another in a longitudinal direction perpendicular to the reference plane 400 of the cover 4. The ribs of the pressing members are in contact with the printed circuit board 5 so that the previously mentioned longitudinal offset provides a clearance 500 between, on the one hand, the printed circuit board 5 and the first transverse plane 451 and, on the other hand, the free end 4501 of the pins 45 and the second transverse plane 452.

It is understood that in order to engage the eyelets 430 with the lugs 33 in order to fix the cover 4 to the base 3 by click and ratchet, it is necessary to exert a force on the cover 4, which force is directed perpendicularly to the aforementioned reference plane 400, the direction of which force is represented by the arrow F1 in FIG. 4.

In particular, the presence of the clearance 500 ensures that the means for fixing by click and ratchet are properly engaged despite the manufacturing and assembly play of the components of the electronic interface housing 300, and prevents the direct transmission of stresses occurring during the fixing by click and ratchet to the printed circuit board 5 and the electrode connection terminals 50.

It is notable that the recessed pressing elements, that is to say the elements that are at a distance from the printed circuit board in the position of the cover placed on the base but not fixed, are arranged in a peripheral position on the cover. In this way, it is easy to press on the cover in this peripheral zone to allow the deformation of the eyelets 430 toward the lugs 33.

The size of the clearance 500 allowing the longitudinal offset between the transverse planes 451 and 452 is calculated on the one hand so as to allow this deformation of the eyelets to ensure the fixing by click and ratchet and on the other hand so as to ensure the contact of the pins 45 forming the pressing element with the printed circuit board when the cover 4 is locked by click and ratchet on the base 3, as illustrated in FIG. 5. The fixing of the cover 4 on the base 3 being an elastic fixing by click and ratchet, the eyelet 430 bears against the corresponding lug 33 by generating a force in the opposite direction to the direction of the previously mentioned pushing force F1 on the cover, which involves a pressing of the pins 45 against the printed circuit board by a tilting effect of the deformed zone 402 toward this board.

The invention thus makes it possible to provide an electronic interface housing 300 of which the cover 4 has, on the one hand, thanks to the pressing members 44a, 44b and the pressing elements 405, a certain rigidity, and, on the other hand, thanks to the clearance 500, a flexibility making it possible to fix said cover on the base 3 of the electronic interface housing 300 with a minimum stress on the fragile elements which are the connecting terminals and assembly of the heating elements of an electrical heating device 100 for a motor vehicle.

The invention as described above nevertheless is not limited to the exclusively described and illustrated means and configurations, and is also applicable to all equivalent means or configurations and to any combination of such means. In particular, the invention applies regardless of the shape of the pressing members and elements, as long as they have the features described in the present document.

1. A cover (4) of an electronic interface housing (300) of an electrical heating device (100) for a motor vehicle, the cover (4) comprising at least one pressing member (44a, 44b) and at least one pressing element (405, 45) which are configured to be in contact with a printed circuit board (5) when the cover (4) is fixed on the electronic interface housing (300), a free end of the at least one pressing member (44a, 44b) extending in a first transverse plane (451) and a free end (4501) of the at least one pressing element (405, 45) extending in a second transverse plane (452), the at least one pressing member (44a, 44b) and the at least one pressing element (405, 45) being arranged so that they project, in a direction perpendicular to a reference plane (400) of the cover (4), from an inner face (401) of the cover (4) intended to face toward the inside of the electronic interface housing (300), characterized in that the first transverse plane (451) and the second transverse plane (452) are substantially parallel to one another and to the reference plane of the cover, strictly not coincident with one another or with the reference plane (400) of the cover (4), the second transverse plane (452) being, in a direction perpendicular thereto, closer to the reference plane (400) of the cover (4) than the first transverse plane (451).

2. The cover (4) as claimed in the preceding claim, characterized in that an offset (500), measured perpendicularly to the reference plane (400), between the first transverse plane (451) and the second transverse plane (452) is in the order of 1 to a few tenths of a millimeter.

3. The cover (4) as claimed in any one of the preceding claims, comprising means (430) for elastic fixing by click and ratchet on a base (3) of the electronic interface housing (300), characterized in that the at least one pressing element (405, 45) is located between a pressing member (44a, 44b) and an edge of the cover on which the means for elastic fixing (430) are arranged.

4. The cover (4) as claimed in any one of the preceding claims, characterized in that the at least one pressing element comprises a plurality of pins (45) arranged so that they project from the inner face (401) of the cover (4), perpendicularly to the reference plane (400) thereof.

5. The cover (4) as claimed in the preceding claim, characterized in that the pins (45) of the at least one pressing element are arranged in a staggered pattern along at least two transverse lines(455, 456).

6. The cover (4) as claimed in any one of preceding claim 4 or 5, characterized in that the pins (45) forming the at least one pressing element are arranged so that they project from a deformed zone (402) of the inner face (401) of the cover (4).

7. The cover (4) as claimed in any one of the preceding claims, characterized in that the at least one pressing member (44a, 44b) comprises at least one rib (441a, 4410b, 4411b) substantially perpendicular to the first transverse plane (451).

8. An electronic interface housing (300) of an electrical heating device (100) of a motor vehicle, comprising a cover (4) as claimed in any one of the preceding claims, as well as a base (3) configured to house a printed circuit board (5), the base (3) comprising click and ratchet means (33) configured to cooperate with means for elastic fixing (43, 430) carried by the cover in (4) order to close a cavity (35) for receiving the printed circuit board (5).

9. The housing (300) according to the preceding claim, comprising an electrical connection zone and a connection zone to heating elements (2) of an electrical heating device (100) of the motor vehicle, characterized in that the pressing element (45) of the cover (4) is located in the vicinity of the connection zone to the heating elements (2) of the electrical heating device (100).

10. The housing (300) as claimed in one of claim 8 or 9, characterized in that the printed circuit board (5) is sandwiched between the at least one pressing member (44a, 44b) of the cover (4) and a reinforcing element (34) arranged in the base (3).

11. An electrical heating device (100) for heating an airflow in a motor vehicle, comprising at least one heating element (2) and an electronic interface housing (300) as claimed in any one of claims 8 to 10.
